(19) United States
(12) Patent Application Publication
(10) Pub. No.: US 2018/0051443 A1
(43) Pub. Date: Feb. 22, 2018

(54) ELECTRIC ROTATING DEVICE

(71) Applicant: KAWASAKI JUKOGYO KABUSHIKI KAISHA, Kobe-shi, Hyogo (JP)

(72) Inventors: Yukito IMAMURA, Kobe-shi (JP); Tadashi ANADA, Kobe-shi (JP); Koji HASHIMOTO, Kobe-shi (JP)

(73) Assignee: KAWASAKI JUKOGYO KABUSHIKI KAISHA, Kobe-shi, Hyogo (JP)

(21) Appl. No.: 15/558,092

(22) PCT Filed: Mar. 10, 2016
(86) PCT No.: PCT/JP2016/001316

§ 371 Date: Sep. 13, 2017

(30) Foreign Application Priority Data
Mar. 13, 2015 (JP) 2015-050800

(51) Int. Cl. E02F 9/20; E02F 9/22; H02K 9/19; H02K 1/27

(52) U.S. Cl. CPC E02F 9/2075; E02F 9/2296; F04B 39/06; H02K 1/2706; H02K 9/19

(57) ABSTRACT

An electric rotating device includes: a casing including an internal space; a rotor accommodated in the internal space of the casing and supported by the casing so as to be rotatable; a stator core accommodated in the internal space of the casing and provided at the casing so as to be located around the rotor with an interval; a plurality of coils provided so as to be spaced apart from one another in a circumferential direction and winding around the stator core; and a cooling liquid enclosed in the inner space of the casing such that a part of the rotor and respective parts of the coils are immersed in the cooling liquid.

### TECHNICAL FIELD

The present invention relates to an electric rotating device configured such that a plurality of coils wind around a stator core arranged around a rotor.

### BACKGROUND ART

One example of a conventional electric apparatus having a power generator function will be explained in reference to FIG. 5 (see PTL 1, for example). An electric apparatus 1 is provided at a hybrid excavator. As shown in FIG. 5, the hybrid excavator includes: a hydraulic pump 2; an electric motor 4 configured to drive the hydraulic pump 2; a hydraulic circuit (not shown) including an actuator portion driven by operating oil ejected from the hydraulic pump 2; and a cooling passage 3 into which drain oil (operating oil) of the hydraulic pump 2 flows. The drain oil of the hydraulic pump 2 flows into the cooling passage 3 to cool the electric motor 4. Thus, the electric motor 4 can be cooled with higher cooling efficiency than an air-cooling method.

### CITATION LIST

### Patent Literature

PTL 1: Japanese Laid-Open Patent Application Publication No. 2010-53596

### SUMMARY OF INVENTION

### Technical Problem

Each of electric motors such as the electric motor 4 included in the electric apparatus 1 shown in FIG. 5 is configured such that: when the electric motor operates, a coil winding around a stator core generates heat; and the generated heat is discharged through the stator core and a casing to an outside. An electric insulating sheet is interposed between the coil and the stator core. Regarding the electric insulating sheet, electrical insulation performance and heat transfer performance tend to conflict with each other. Therefore, if the electrical insulation property of the electric insulating sheet is improved, heat transfer is disturbed by the electric insulating sheet. On this account, the heat generated by the coil is hardly discharged to the outside of the casing. Thus, in the case of reducing the size of the electric motor or improving the performance of the electric motor, how to cool the coil is important.

The present invention was made to solve the above problems, and an object of the present invention is to provide an electric rotating device capable of improving cooling performance of coils.

### Solution to Problem

An electric rotating device of the present invention includes: a casing including an internal space; a rotor accommodated in the internal space of the casing and supported by the casing so as to be rotatable; a stator core accommodated in the internal space of the casing and provided at the casing so as to be located around the rotor with an interval; a plurality of coils provided so as to be spaced apart from one another in a circumferential direction and winding around the stator core; and a cooling liquid enclosed in the inner space of the casing such that a part of the rotor and respective parts of the coils are immersed in the cooling liquid.

According to the electric rotating device of the present invention, when the rotor rotates, the cooling liquid in the casing is stirred by centrifugal force to be moved toward the stator core. With this, a large number of coils provided at the stator core can contact the cooling liquid, so that the heat can be removed from the coils by the cooling liquid. The heat removed by the cooling liquid is indirectly transferred to the casing through the stator core or directly transferred to the casing and can be discharged to an outside of the casing through the casing. To be specific, the heat of the coils can be discharged through the cooling liquid, the stator core, and the casing to the outside of the casing. Thus, the cooling performance of the coils can be improved. With this, for example, when an electric insulating layer is provided between the coil and the stator, the coil can be cooled while securing performance of the electric insulating layer.

In the present invention, it is preferable that the electric rotating device be such a vertical type that a rotating shaft of the rotor is arranged substantially in parallel with a vertical direction.

According to the above configuration, by the centrifugal force generated by the rotation of the rotor, the cooling liquid is moved toward the stator core over the entire periphery of the rotor, and a liquid surface of the cooling liquid forms a mortar shape. With this, all of the coils can be immersed in the cooling liquid, and the coils can be entirely immersed in the cooling liquid. Therefore, all the coils can be entirely and efficiently cooled.

According to the above configuration, the cooling liquid moved toward the stator core by the centrifugal force flows upward along an inner surface of the casing and then flows downward along the mortar-shaped liquid surface toward the rotor. After the cooling liquid reaches the vicinity of the rotor, the cooling liquid is again moved toward the inner surface of the casing by the centrifugal force. As above, the cooling liquid can be circulated in the internal space of the casing. By circulating the cooling liquid, the cooling liquid in the casing can be prevented from locally becoming high in temperature. Thus, the electric rotating device can be efficiently cooled.

In the present invention, it is preferable that an amount of the cooling liquid enclosed in the internal space of the casing be set such that: an amount of heat discharged from the casing per unit time is larger than an amount of heat transferred from the coils to the cooling liquid per unit time; and the amount of heat transferred per unit time becomes a maximum value or a value close to the maximum value.

According to the above configuration, the amount of cooling liquid enclosed in the internal space of the casing is set such that the amount of heat discharged from the casing per unit time becomes larger than the amount of heat transferred from the coils to the cooling liquid per unit time. With this, an entire amount of heat generated by the coils can be discharged through the cooling liquid and the casing to the outside. Thus, the heat can be prevented from being accumulated in the internal space of the casing, and the coils can be efficiently cooled. Further, the amount of cooling liquid is set such that the amount of heat discharged from the casing per unit time becomes the maximum value or a value close to the maximum value. With this, an ability of the cooling liquid that removes heat from the coils can be maximally extracted. Thus, a significant cooling effect of the coils can be obtained.

The electric rotating device according to the present invention may be an electric motor, a power generator, or an electric motor having a power generator function.

This electric rotating device can be applied as an electric motor, a power generator, or an electric motor having a power generator function.

The electric rotating device according to the present invention may be a turning electric motor of a construction machine.

Since the turning electric motor of the construction machine repeatedly starts up and stops many times and generates a large amount of heat, the electric rotating device according to the present invention is effective for preventing overheat.

### Advantageous Effects of Invention

The present invention can improve the cooling performance of the coils.

The above object, other objects, features, and advantages of the present invention will be made clear by the following detailed explanation of preferred embodiments with reference to the attached drawings.

### BRIEF DESCRIPTION OF DRAWINGS

FIG. 1 is a longitudinal sectional view showing a principle of an electric rotating device according to one embodiment of the present invention.

FIG. 2 is a longitudinal sectional view showing a circulation passage of a cooling liquid enclosed in a casing of the electric rotating device shown in FIG. 1.

FIG. 3 is a diagram showing a relation among the amount of enclosed cooling liquid shown in FIG. 1, the amount of heat transferred to the cooling liquid, and the amount of heat discharged from the casing.

FIG. 4 is a side view showing a construction machine at which the electric rotating device shown in FIG. 1 is provided.

FIG. 5 is a circuit diagram showing an electric motor provided at a conventional hybrid excavator and having a power generator function.

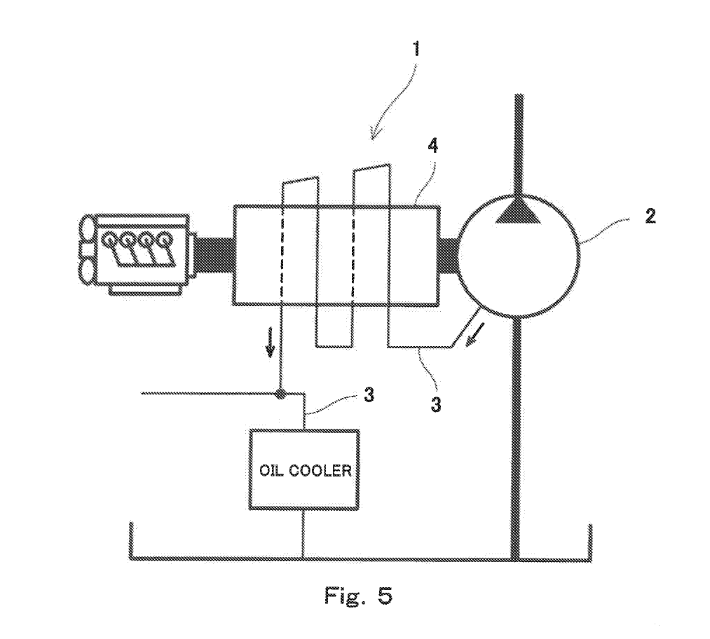

### DESCRIPTION OF EMBODIMENTS

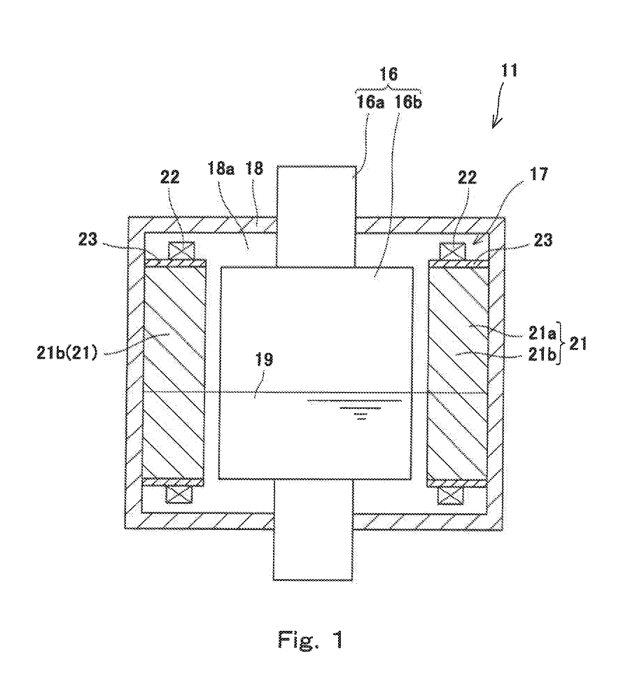

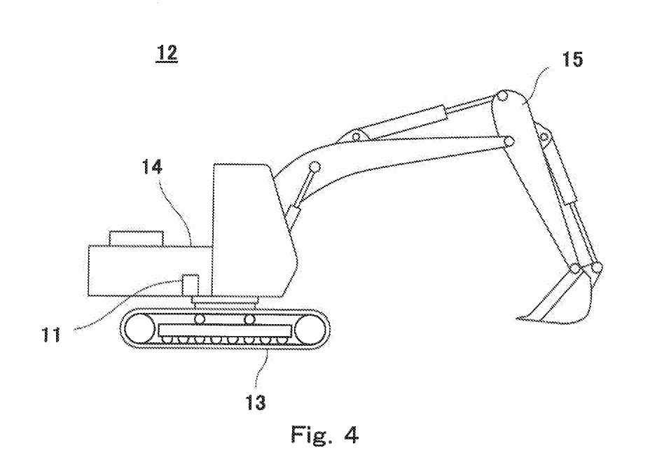

Hereinafter, one embodiment of an electric rotating device according to the present invention will be explained in reference to FIGS. 1 to 4. An electric rotating device 11 can be applied as an electric motor, a power generator, or an electric motor having a power generator function. The electric rotating device 11 can be used in various machines and apparatuses such as construction machines. The present embodiment will explain an example in which the electric rotating device 11 is applied as a turning vertical electric motor of a construction machine 12 shown in FIG. 4. As one example of the construction machine 12, FIG. 4 shows a hydraulic excavator. However, the construction machine 12 may be a crane or the like. The construction machine 12 may or may not be a hybrid type using oil pressure and electricity.

The hydraulic excavator (construction machine) 12 shown in FIG. 4 includes: a base carrier 13; a revolving super structure 14 mounted on the base carrier 13 so as to be turnable; and an excavating work machine 15 attached to the revolving super structure 14 and configured to perform excavating work and the like. The electric rotating device 11 is mounted on the revolving super structure 14 and driven by electricity stored in a power storage device (not shown). The revolving super structure 14 is turned by driving force of the electric rotating device 11. Further, the revolving super structure 14 is turned by driving force of a hydraulic motor (not shown).

As shown in FIG. 1, the electric rotating device 11 is, for example, a turning vertical three-phase electric motor, and a rotating speed of the electric rotating device 11 is controlled by an inverter. The electric rotating device 11 includes a rotor 16, a stator 17, a casing 18, and a cooling liquid 19.

The rotor 16 includes a rotating shaft 16a. A columnar rotor main body 16b is provided at the rotating shaft 16a. Both end portions of the rotating shaft 16a are supported by the casing 18 through bearings (not shown) such that the rotating shaft 16a is rotatable. The rotating shaft 16a of the rotor 16 is arranged substantially in parallel with a vertical direction. Thus, the electric rotating device 11 is used as a vertical electric motor. The stator 17 is arranged around the rotor 16 with an interval therebetween.

The stator 17 is a so-called stator and includes: a stator core 21 formed by stacking thin steel plates; and a plurality of coils 22. The stator core 21 includes a yoke portion 21a and a plurality of teeth portions 21b. The yoke portion 21a is formed in a substantially cylindrical shape. The plurality of teeth portions 21b are integrally provided on an inner peripheral surface of the yoke portion 21a. Each of the teeth portions 21b projects from the inner peripheral surface of the yoke portion 21a in a radially inward direction and is formed to be long in an upward/downward direction. The teeth portions 21b are arranged on the inner peripheral surface of the yoke portion 21a at regular intervals in a circumferential direction. The coils 22 wind around the respective teeth portions 21b through electric insulating sheets 23 having an electrical insulation property. The coils 22 are arranged at regular intervals in the circumferential direction.

The stator 17 configured as above is provided so as to be fixed to an inner peripheral surface of the casing 18. The inner peripheral surface of the casing 18 is formed to be cylindrical around the rotating shaft 16a of the rotor 16. The stator 17 is arranged on the inner peripheral surface of the casing 18 such that an outer peripheral surface of the stator core 21 is provided along the inner peripheral surface of the casing 18. As above, the rotor 16 and the stator 17 are accommodated in an inner space 18a of the casing 18. In addition, a predetermined amount of cooling liquid 19 is enclosed in the inner space 18a of the casing 18.

The cooling liquid 19 is a heat medium that removes heat generated by the coils 22 that are main heat sources and transfers the heat to the stator core 21 and the casing 18. The cooling liquid 19 transfers the heat of the coils 22 indirectly or directly to the casing 18 and discharges the heat to an outside through the casing 18. The cooling liquid 19 is enclosed in the inner space 18a of the casing 18. A part of the rotor 16 and a part of the stator 17 (more specifically, a lower end portion of the rotor 16 and lower end portions of the coils 22) are immersed in the cooling liquid 19. Used as the cooling liquid 19 is insulating oil having electrical insulation performance to prevent electric conduction among various components. It is preferable that the electrical insulation performance of the insulating oil be stable for a long period of time. Further, it is preferable the cooling liquid 19 be low in viscosity in an operating temperature range of the electric rotating device 11. With this, bubbles formed in the cooling liquid 19 easily rise to a liquid surface 19a, and the formation of the bubbles in the liquid can be suppressed. Further, the bubbles risen to the liquid surface 19a can be easily extinguished. With this, a decrease in cooling ability by the bubbles can be suppressed. The cooling liquid 19 may obtain a deforming property by adding an antifoaming agent to the insulating oil. As with the above, the decrease in cooling ability by the bubbles can be suppressed by the cooling liquid 19 to which the antifoaming agent is added.

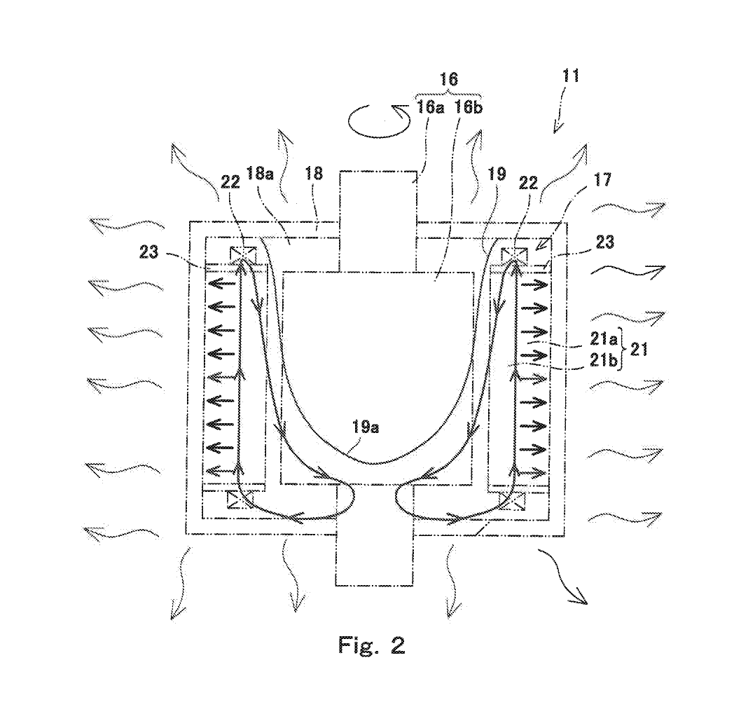

Next, the movement of the cooling liquid 19 in the electric rotating device 11 will be explained in reference to FIG. 2. As described above, the electric rotating device 11 is a turning vertical three-phase electric motor. By the rotation of the rotor 16, the cooling liquid 19 in the casing 18 rotates in the same direction around the rotor 16, and centrifugal force is applied to the cooling liquid 19. With this, the cooling liquid 19 is moved toward the stator 17, and the liquid surface 19a of the cooling liquid 19 is formed in a mortar shape. With this, the coils 22 are entirely immersed in the cooling liquid 19, that is, in the present embodiment, the entire coils 22 from lower end portions thereof to upper end portions thereof are immersed in the cooling liquid 19, so that the heat of the entire coils 22 can be transferred from the entire coils 22 to the cooling liquid 19. Therefore, the entire coils 22 can be effectively cooled.

Further, the cooling liquid 19 circulates in the inner space 18a of the casing 18 by the rotation of the rotor 16. To be specific, the cooling liquid 19 flows in the vicinity of the rotor 16 to be moved from the rotor 16 toward the stator 17 and further flows upward along the coils 22 through spaces each between the yoke portion 21a of the stator core 21 and the teeth portion 21b. In addition, the cooling liquid 19 flows upward and also gets into gaps of the stator core 21 to reach the inner peripheral surface of the casing 18 through the gaps. With this, a contact area of the cooling liquid 19 with the inner peripheral surface of the casing 18 increases. When the cooling liquid 19 reaches the liquid surface 19a, it flows downward along the liquid surface 19a toward the rotor 16. When the cooling liquid 19 reaches the rotor 16, the cooling liquid 19 is again moved toward the stator 17 by the rotor 16. As above, the cooling liquid 19 circulating in the inner space 18a removes the heat from the coils 22, transfers the heat directly to the casing 18 or indirectly to the casing 18 through the stator core 21, and discharges the heat to the outside through the casing 18. With this, even when the electric insulating sheet 23 is interposed between the coil 22 and the stator core 21, the heat of the coil 22 can be discharged through the cooling liquid 19 and the casing 18 to the outside, so that the coils 22 can be efficiently cooled. Further, by circulating the cooling liquid 19, the cooling liquid 19 can also remove heat from the rotor 16 and the stator core 21 and discharge the heat through the casing 18 to the outside. As above, the heat can be removed from the components 16, 21, and 22 and discharged through the casing 18 to the outside. Thus, the entire electric rotating device 11 can be efficiently cooled. Further, by circulating the cooling liquid 19, the cooling liquid 19 in the inner space 18a can be prevented from locally becoming high in temperature. Thus, the electric rotating device can be efficiently cooled.

According to the electric rotating device 11 configured as above, it is unnecessary to provide pipes and passages of the cooling liquid 19 close to heat generating portions. Thus, the electric rotating device 11 that is low in cost and small in size can be produced. Further, since the cooling liquid 19 is enclosed in the inner space 18a of the casing 18, the cooling liquid 19 is not heated from an outside of the electric rotating device 11. Therefore, the electric rotating device 11 can realize a stable cooling characteristic.

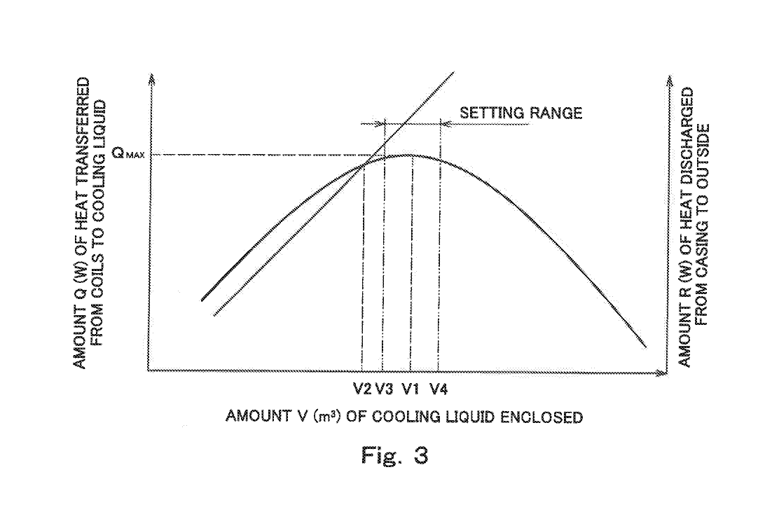

According to the electric rotating device 11 configured as above, the amount of heat transferred from the coils 22 to the cooling liquid 19 per unit time and the amount of heat discharged from the casing 18 to the outside per unit time change in accordance with the amount of cooling liquid 19 enclosed in the inner space 18a. Referring to FIG. 3, the following will explain a relation among an amount V (m³) of cooling liquid 19 in the electric rotating device 11, an amount Q (W) of heat transferred from the coils 22 to the cooling liquid 19 per unit time, and an amount R (W) of heat discharged from the casing 18 to the outside per unit time.

A change in the amount Q of heat transferred from the coils 22 per unit time with respect to the amount V (m³) of cooling liquid 19 enclosed in the casing 18 forms a parabola in which the amount Q of heat transferred becomes a maximum heat transfer amount Q_{MAX} when the amount V of cooling liquid 19 is a predetermined liquid amount V1. In each of a case where the amount of cooling liquid 19 is larger than the predetermined liquid amount V1 and a case where the amount of cooling liquid 19 is smaller than the predetermined liquid amount V1, the amount Q of heat transferred from the coils 22 to the cooling liquid 19 per unit time becomes smaller than the maximum heat transfer amount Q_{MAX}. A reason why the change in the amount Q of heat transferred from the coils 22 to the cooling liquid 19 per unit time with respect to the amount V of cooling liquid 19 forms the parabola, and the amount Q of heat transferred becomes smaller when the amount V of cooling liquid 19 is smaller than the liquid amount V1 is because an area of surfaces of the coils 22 which surfaces contact the cooling liquid 19 becomes small. Another reason is because when the amount V of cooling liquid 19 is larger than the liquid amount V1, the amount of heat transferred from the coils 22 to the cooling liquid 19 becomes small by heat generated by stirring the cooling liquid 19.

The amount R of heat discharged per unit time is an amount of heat generated in the casing 18 and discharged through the casing 18 to the outside per unit time, and examples of the heat generated in the casing 18 include: heat generated at the coils 22 and the like by current flowing through the coils 22 by the operation of the electric rotating device 11; and heat generated by stirring the cooling liquid 19 by the rotor 16. The contact area of the rotor 16 with the cooling liquid 19 increases as the amount V of cooling liquid 19 increases. Therefore, the amount R of heat discharged per unit time increases in proportion to the amount V of cooling liquid 19 in the casing 18.

Regarding the amount Q of heat transferred per unit time and the amount R of heat discharged per unit time which amounts have the above characteristics, when the amount V of cooling liquid 19 is small (i.e., less than a liquid amount V2), the amount Q of heat transferred per unit time exceeds the amount R of heat discharged per unit time. In this case, the amount of heat dischargeable to the outside of the casing 19 becomes small with respect to the heat generated by the coils 22. This may cause a case where the coils 22 overheat, and it becomes difficult to continue the operation. Therefore, in the electric rotating device 11, it is preferable that the amount V of cooling liquid 19 be set, that is, the amount V of cooling liquid 19 be set to be not less than the liquid amount V2 such that the amount Q of heat transferred per unit time becomes smaller than the amount R of heat discharged per unit time. Further, in the electric rotating device 11, to remove a larger amount of heat from the coils 22, the amount of cooling liquid 19 is set, that is, the amount V of cooling liquid 19 is set in a setting range of not less than a liquid amount V3 and not more than a liquid amount V4 such that the amount Q of heat transferred per unit time becomes the maximum heat transfer amount Q_{MAX} or a value close to the maximum heat transfer amount Q_{MAX} (i.e., a value in a range around the maximum heat transfer amount Q_{MAX}). It should be noted that each of the liquid amounts V3 and V4 is larger than the liquid amount V2.

As above, the amount V of cooling liquid 19 in the casing 18 is set to such an amount that the amount Q of heat transferred per unit time becomes smaller than the amount R of heat discharged per unit time. With this, the coils 22 can be efficiently cooled. Further, the electric rotating device 11 configured as above can be adopted as a turning electric motor of the construction machine 12 such as an electric excavator. The turning electric motor repeatedly starts up and stops many times and generates a large amount of heat. However, by adopting the electric rotating device 11, the cooling can be effectively performed, and the overheating can be prevented.

In the embodiment, the electric rotating device 11 is applied as the electric motor. Instead of this, the electric rotating device 11 may be applied as a power generator or an electric motor having a power generator function.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the scope of the present invention.

### REFERENCE SIGNS LIST

11 electric rotating device
12 construction machine
13 base carrier
14 revolving super structure
15 excavating work machine
16 rotor
16a rotating shaft
16b rotor main body
17 stator
18 casing
18a internal space
19 cooling liquid
21 stator core
22 coil

1. An electric rotating device comprising:
a casing including an internal space;
a rotor accommodated in the internal space of the casing and supported by the casing so as to be rotatable;
a stator core accommodated in the internal space of the casing and provided at the casing so as to be located around the rotor with an interval;
a plurality of coils provided so as to be spaced apart from one another in a circumferential direction and winding around the stator core; and
a cooling liquid enclosed in the inner space of the casing such that a part of the rotor and respective parts of the coils are immersed in the cooling liquid.

2. The electric rotating device according to claim 1, wherein the electric rotating device is such a vertical type that a rotating shaft of the rotor is arranged substantially in parallel with a vertical direction.

3. The electric rotating device according to claim 1, wherein an amount of the cooling liquid enclosed in the internal space of the casing is set such that: an amount of heat discharged from the casing per unit time is larger than an amount of heat transferred from the coils to the cooling liquid per unit time; and the amount of heat transferred per unit time becomes a maximum value or a value close to the maximum value.

4. The electric rotating device according to claim 1, wherein the electric rotating device is an electric motor, a power generator, or an electric motor having a power generator function.

5. The electric rotating device according to claim 2, wherein the electric rotating device is a turning electric motor of a construction machine.
